(19) United States
(12) Patent Application Publication
(10) Pub. No.: US 2006/0263073 A1
(43) Pub. Date: Nov. 23, 2006

(54) Multi-power multi-stage electric heater

(75) Inventors: Brian D. Clarke, Bellingham, MA (US); Robert Ashworth, Littleton, MA (US); John Lee Crawford, Uxbridge, MA (US); Sean Crossman, Providence, RI (US); Randall Clayton Hoover, Woodstock, CT (US); Charles Thomas Thrasher JR., Millville, MA (US); Danny Xu, Quincy, MA (US)

Correspondence Address: HOFFMANN & BARON, LLP, 6900 JERICHO TURNPIKE, SYOSSET, NY, 11791, US

(73) Assignee: JCS/THG,LLP.

(21) Appl. No.: 11/438,682

(22) Filed: May 22, 2006

Related U.S. Application Data
(60) Provisional application No. 60/683,757, filed on May 23, 2005.
(60) Provisional application No. 60/793,080, filed on Apr. 19, 2006.

(51) Int. Cl. F24D 13/00; H05B 1/02

(52) U.S. Cl. 392/347; 219/486; 219/490

(57) ABSTRACT

A heater operates at a first power to heat a space and a second power to maintain the temperature. The heater uses a first heating element and a second heating element, which are configured to automatically supply the first power during an initial heating period, then step down to the second power for continuous operation. The heater may use a phase chopper circuit and heating element; switched diode and heating element; positive temperature coefficient thermostat, isolated heater, and heating element; latching mechanical timer switch and heating element; and/or a positive temperature coefficient heating element and multi-speed fan to provide dual power levels. The heater may include a first heating element energized during a portion of a heating cycle and a second heating element continuously energized during the heating cycle. The heating cycle is repeated for a period after which both elements are de-energized.

### CROSS REFERENCE TO RELATED APPLICATIONS

This application claims the benefit of U.S. Provisional Application No. 60/683,757, filed on May 23, 2005, and U.S. Provisional Application No. 60/793,080, filed on Apr. 19, 2006, of the same title, the disclosures of which are incorporated herein by reference.

### BACKGROUND OF THE INVENTION

1. Field of the Invention

The present invention relates to electric heaters, and more particularly relates to an electric heater capable of operating at different power levels.

2. Description of the Related Art

Portable electric heaters are currently limited to a continuous power rating of no greater than 1500 watts. This limit is designed to reduce the risk of fire associated with continuous-use heating devices operating at capacities beyond this power rating. This limit is also enforced by product certification agencies, such as Underwriters Laboratories, and model codes, such as the National Electric Code.

However, in an enclosed space to be heated, the operation of a heater at 1500 watts or less results in extended heating times. Therefore, there is a need for an electric heater that operates at a higher power rating during an initial heating cycle when the space to be heated is at its coldest, and then operates at a lower power rating during the remaining continuous heating operation. There is also a need for an electric heater that cyclically operates at the higher power rating for a first period of time followed by operation at the lower power rating for a second period of time to save energy.

### OBJECTS AND SUMMARY OF THE INVENTION

It is an object of the present invention to provide an electric heater that will rapidly heat a given space without increasing the risk of fire.

It is another object of the present invention to provide a multi-stage electric heater that operates at an initial higher power level (such as 1800 W) at the beginning of a heating cycle, then automatically drops to one or more lower power levels for continuous and/or thermostatic operation (such as 1000 W) followed by thermostatic operation at 500 W.

It is yet another object of the present invention to provide a multi-stage electric heater, which cannot be forced by the user to operate continuously at a high power level.

It is another object of the present invention to provide a multi-stage electric heater that operates at a higher power level (such as 1500 W) during a first portion of a heating cycle, then automatically drops to a lower power level for a second portion of the heating cycle, wherein this heating cycle repeats for a predetermined number of times or continuously.

It is yet another object of the present invention to provide an electric heater that will rapidly heat a given space while saving energy.

In accordance with the present invention, a portable electric space heater is provided that includes a first heating element and a power modification circuit electrically connected in series with the first heating element. The power modification circuit is adapted to selectively modify power provided to the first heating element, thereby enabling the electric space heater to operate at at least one of a first operating power and a second operating power. The power modification circuit may include a phase chopper adapted to conduct a selectable portion of an AC power signal to the first heating element in response to a timing signal. The phase chopper may include at least one of a thyristor, triac, diac, and silicon controlled rectifier. The heater may include a second heating element electrically connected in parallel with the series combination of the first heating element and the phase chopper.

The power modification circuit may include a pulse width modulator adapted modulate a rectified AC power signal in response to a timing signal and conduct the modulated rectified AC power signal to the first heating element, thereby enabling the electric space heater to operate at at least one of the first operating power and the second operating power. The pulse width modulator may include a field effect transistor. The heater may include a second heating element electrically connected in parallel with the series combination of the first heating element and the pulse width modulator.

The power modification circuit may also include a switch adapted to selectively provide one of a closed circuit and an open circuit in response to a timing signal, and a diode electrically connected in parallel with the switch. The diode may be adapted to rectify an AC power signal and conduct the rectified AC power signal to the first heating element in response to the switch providing an open circuit, thereby enabling the electric space heater to operate at the first operating power. The switch may provide a bypass path for the AC power signal in response to the switch providing a closed circuit, thereby enabling the electric space heater to operate at the second operating power. The heater may also include a second heating element electrically connected in parallel with the series combination of the first heating element and the diode.

In accordance with another aspect of the present invention, a portable electric space heater is provided that includes a first heating element, a second heating element electrically connected in series with the first heating element, and a switch electrically connected in parallel with the second heating element. The switch selectively provides a closed circuit, thereby enabling an AC power signal to substantially bypass the second heating element and enabling the electric space heater to operate at a first operating power. The switch also selectively provides an open circuit, thereby enabling the AC power signal to flow through the second heating element and enabling the electric space heater to operate at a second operating power.

The switch may also include a third heating element and a thermostatic switch selectively providing one of the closed circuit and the open circuit in response to heat dissipated by the third heating element. The third heating element may be electrically connected in parallel with the thermostatic switch, and the switch may include a mechanical timer switch.

In accordance with yet another aspect of the present invention, a portable electric space heater is provided that includes a first heating element, a second heating element, and a switch electrically connected in series with the second heating element. The first heating element is electrically connected in parallel with the series combination of the switch and the second heating element. The switch selectively provides an open circuit, thereby enabling an AC power signal to substantially bypass the second heating element and enabling the electric space heater to operate at a first operating power. The switch also selectively provides a closed circuit, thereby enabling the AC power signal to be provided to the second heating element and enabling the electric space heater to operate at a second operating power.

The switch may also include a third heating element, and a thermostatic switch selectively providing one of the closed circuit and the open circuit in response to heat dissipated by the third heating element. The third heating element may be electrically connected in parallel with the thermostatic switch, and the switch may include a mechanical timer switch.

In accordance with still another aspect of the present invention, a portable electric space heater is provided that includes a fan adapted to move a volume of air, and a first heating element adapted to selectively operate at different powers in response to the volume of air moved across the first heating element by the fan, thereby enabling the electric space heater to operate at at least one of a first operating power and a second operating power. The first heating element may include a positive temperature coefficient (PTC) ceramic heating element. The heater may include an inrush limiter electrically connected in series with the first heating element, and a second heating element electrically connected in parallel with the first heating element.

These and other objects, features, and advantages of this invention will become apparent from the following detailed description of illustrative embodiments thereof, which is to be read in connection with the accompanying drawings.

### BRIEF DESCRIPTION OF THE DRAWINGS

FIG. 1 is a schematic diagram of a first embodiment of a heater circuit.

FIG. 2 is a schematic diagram of a second embodiment of a heater circuit.

FIG. 3 is a schematic diagram of a third embodiment of a heater circuit.

FIGS. 4a and 4b are schematic diagrams of fourth and fifth embodiments, respectively, of a heater circuit formed in accordance with the present invention.

FIGS. 5a and 5b are schematic diagrams of sixth and seventh embodiments, respectively, of the heater circuit formed in accordance with the present invention.

FIGS. 6a and 6b are schematic diagrams of eighth and ninth embodiments, respectively, of the heater circuit formed in accordance with the present invention.

FIGS. 7a and 7b are schematic diagrams of tenth and eleventh embodiments, respectively, of the heater circuit formed in accordance with the present invention.

FIGS. 8a and 8b are schematic diagrams of twelfth and thirteenth embodiments, respectively, of the heater circuit formed in accordance with the present invention.

FIG. 9 is a simplified block diagram of a fourteenth embodiment of the heater circuit formed in accordance with the present invention.

FIG. 10 is a table showing timing and power information concerning heating cycles provided by the fourteenth embodiment of the heater circuit shown in FIG. 9.

FIG. 11 is a schematic diagram of the fourteenth embodiment of the heater circuit shown in FIG. 9.

### DETAILED DESCRIPTION OF THE PREFERRED EMBODIMENTS

When an enclosed space is to be heated, it is desirable to operate a portable space heater at the highest allowable power level during an initial time period of the heating cycle, i.e., when the space is at its coldest temperature. To reduce the risk of fire associated with high-power operation, it is also desirable to operate the heater at a second reduced power level following the initial period.

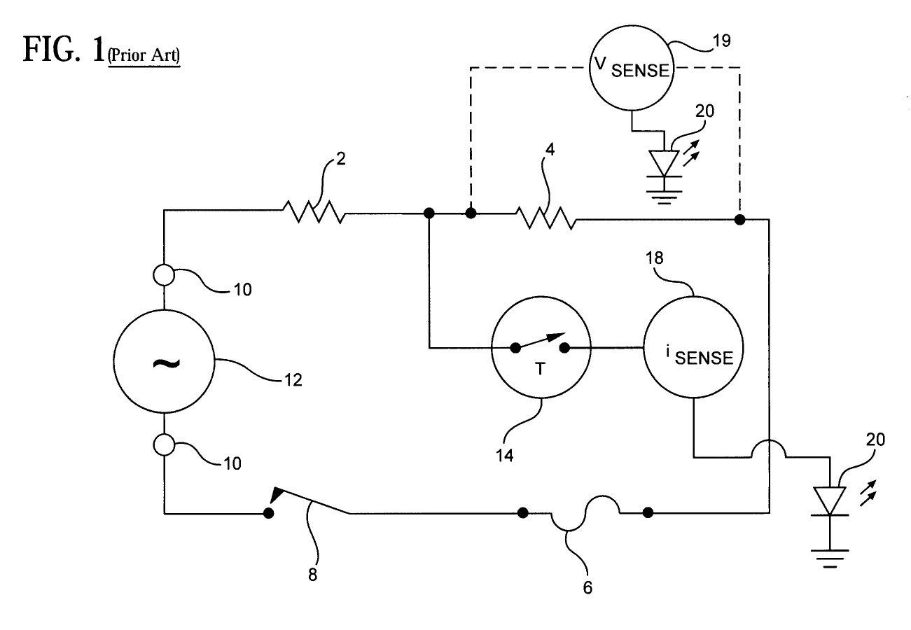

FIG. 1 is a schematic diagram of a first embodiment of a heater circuit described in U.S. Pat. No. 6,233,397, which is incorporated herein by reference. The heater of FIG. 1 includes a series circuit formed by the connection of a first resistive heating element 2, a second resistive heating element 4, a thermal fuse 6 and a high-limit normally closed thermostat 8. Terminals 10 are included to attach the series circuit to an external power source 12.

The heater circuit of FIG. 1 further includes a thermal switch 14, which is connected in parallel with the second resistive heating element 4. Thermal switch 14 operates in a normally closed (low-resistance) state when the device is at a first temperature, and an open (high-resistance) state upon reaching a second, higher temperature. Preferably, thermal switch 14 is a positive temperature coefficient (PTC) device that latches in the open state until power is removed from the circuit or the user intervenes.

When the power source 12 is first connected to the series circuit, the thermal switch 14 is in its initial, closed state. This places a short circuit across the second resistive heating element 4. Accordingly, the initial resistance of the series circuit is the resistance of the first resistive heating element 2. Upon reaching a predetermined temperature (preferably associated with a predetermined time), the thermal switch 14 opens. This connects the second resistive heating element 4 into the series circuit and increases the total circuit resistance. The increased total circuit resistance lowers the power output of the heater for the remaining, continuous operation of the heater. As previously discussed, the use of a latching type device for the thermal switch 14 is preferred. This prevents the heater circuit from inadvertently reverting to the high-power mode.

FIG. 1 further illustrates the use of an optional current sensor 18. The current sensor 18 is connected in series with the thermal switch 14. The current sensor 18 is preferably a low-resistance device that detects current flow and activates a display element 20 to indicate the mode of operation of the heater, i.e., high-power, fast-heating mode, or constant-power mode. Alternatively, a voltage sensor 19 may be operatively coupled across the second resistive heating element 4 to perform the mode detection function, as indicated by dashed lines in FIG. 1. As another alternative, the glow from at least one of the heating elements may be channeled or otherwise used to illuminate an indicator so that the user is able to determine the state of operation of the heater. For example, the glow from heating element 4 may be used as an indicator to differentiate between the high- and low-power modes.

Any or all of the above-described alternatives may be utilized in any or all of the embodiments of the heater circuit described herein while remaining within the scope of the present invention. For embodiments with parallel heating elements, the display element 20 may be electrically connected in parallel with the heating element that is energized during the high-power mode to indicate the high-power mode of operation.

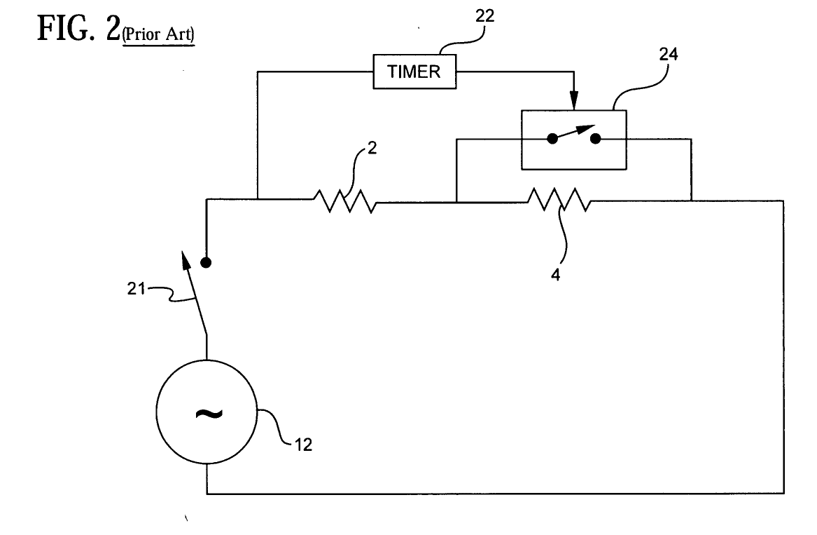

FIG. 2 illustrates a second embodiment of a heater circuit described in U.S. Pat. No. 6,233,397. The heater circuit in FIG. 2 includes the first resistive heating element 2, second resistive heating element 4, power source 12, and a single pole, single throw (SPST) switch 21 connected as a single series circuit. The heater further includes an electrically controllable switch 24.

The electrically controllable switch 24 includes first and second switch terminals that are electrically connected across the second heating element 4. The electrically controllable switch 24 also includes at least a third control terminal that receives a control signal. In response to the received control signal, the switch terminals open (high resistance) or close (low resistance). The electrically controllable switch 24 may take the form of a solid-state switch or conventional relay. In this circuit configuration, when the switch terminals are closed, the second heater element 4 is bypassed (shorted) in the series circuit. This reduces the total circuit resistance and increases the power rating of the heater. As with the thermal switch 14, it is preferable that once the electrically controllable switch 24 is opened, it remains latched in this state until the circuit is de-energized or the user intervenes, such as by depressing a button.

The heater circuit of FIG. 2 further includes a timer circuit 22. The timer circuit 22 includes an input terminal, which is electrically connected to the series circuit, and an output terminal, which is electrically connected to the control terminal of the electrically controllable switch 24. The timer circuit 22 detects when the series circuit is energized (SPST switch 20 closed). This condition initializes the timer output terminal to a first state that closes switch 24. Accordingly, the heater is initially in a high output mode to quickly warm the environment when the most heat is needed.

After a predetermined time, the timer circuit 22 changes the state of the output terminal by opening switch 24. With switch 24 open, the second resistive heating element 4 is connected in the series circuit, thereby reducing the power output of the heater for the remaining heating period. Thus, the heater operates continuously at the lower power level. The timer circuit 22 may be realized by using an appropriately configured 555 integrated circuit timer or other timing circuits implemented using means well known in the art, such as microprocessors, microcontrollers, application specific integrated circuits (ASICs), programmable logic, discrete logic, and the like.

As an illustrative example, the heater circuit of FIGS. 1 and 2 may be designed to provide 1800 watts of heat during the initial heating period and drop to 1500 watts of heat output for the balance of the heating period. This is preferably achieved by selecting the first resistive heating element 2 to have a resistance of approximately 8 ohms, the second resistive heating element 4 to have a resistance of approximately 1.6 ohms, and the power source to have a voltage potential of approximately 120 volts AC. Initially, when the second resistive heating element 4 is bypassed, the total resistance of the series circuit is 8 ohms. When the second resistive heating element is connected in the circuit, the total resistance of the series circuit increases to 9.6 ohms. As the voltage from power source 12 remains a substantially constant 120 volts AC, this change in resistance effectively alters the power rating of the heater.

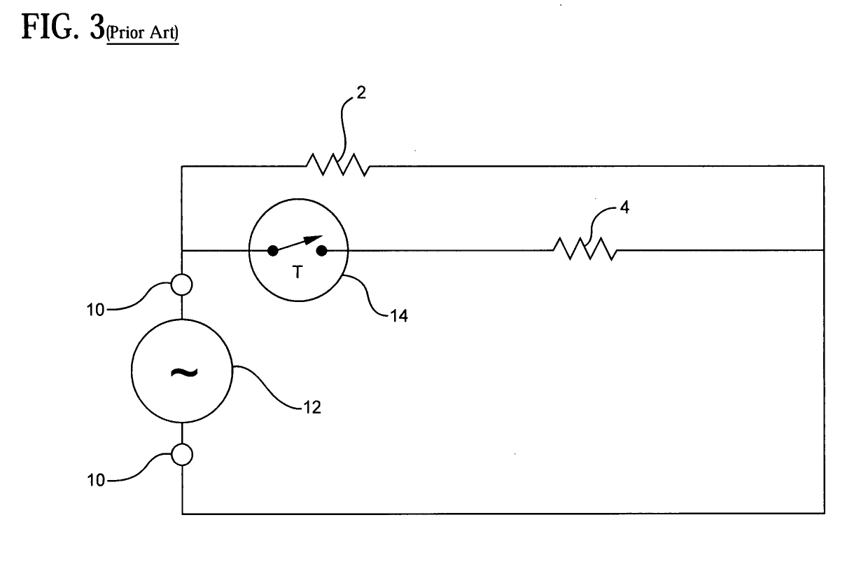

FIG. 3 shows an embodiment of a two-stage heater circuit described in U.S. Pat. No. 6,233,397 using a parallel arrangement of heating elements. In this embodiment, the first resistive heating element 2 is connected in parallel with a series combination of a thermal switch 14 and the second resistive heating element 4. The external power source 12 is preferably coupled across the parallel circuit by connection to terminals 10.

As with the circuits of FIGS. 1 and 2, the heater of FIG. 3 operates at an initial high-power level for a first time period, then drops to a reduced power level for continuous operation. When the thermal switch 14 is closed, the resistance of the first and second heating elements combine in parallel to form a reduced combined resistance. When the thermal switch 14 is opened, the first resistive heating element is the only resistance in the circuit, thereby increasing the total circuit resistance and reducing the operating power. It will be appreciated that the thermal switch 14 may be replaced with other automatic control means, such as the timer circuit 22 and electrically controllable switch 24 shown in FIG. 2.

As an example of the operation of the circuit in FIG. 3, the heater circuit of the present invention may be constructed to provide 1800 watts during the initial heating period and revert to outputting 1500 watts for the balance of the heating period. This is preferably achieved by selecting the first resistive heating element to have a resistance of 9.6 ohms, the resistance of the second resistive heating element to have a resistance of 48 ohms, and the external power source to supply a voltage of 120 volts AC. When power is first applied to the circuit, the thermal switch 14 is preferably closed and the total resistance of this circuit is the parallel combination of 48 ohms and 9.6 ohms. This total resistance is equal to 8 ohms. After a predetermined time, the thermal switch 14 preferably opens and increases the resistance of the circuit to that of the first resistive heating element, or 9.6 ohms. Alternatively, switching may be triggered by reaching a predetermined ambient temperature (for example, when the heater completes its function of heating the living space). The switching function could be based on time only, temperature only, or time and temperature, with whichever occurs first (reaching the predetermined temperature or the elapsed time) actuating the switching function.

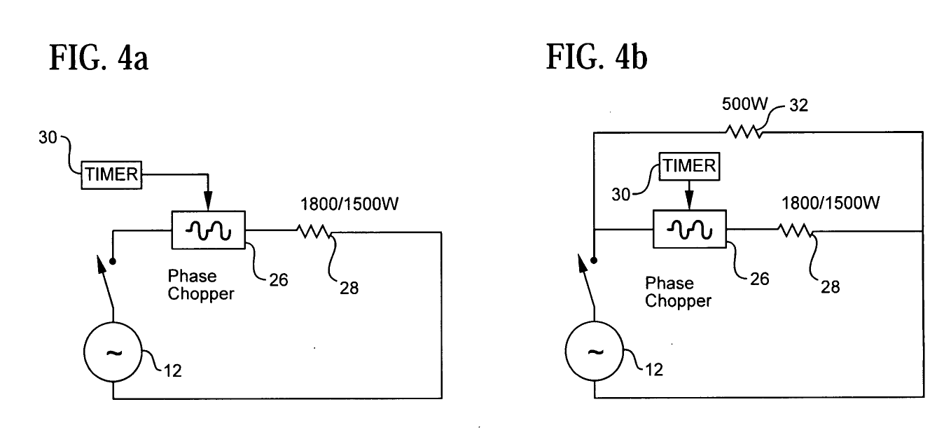

FIG. 4a shows a fourth embodiment of a two-stage heater circuit formed in accordance with the present invention using a phase chopper circuit 26 connected in series with a resistive heating element 28 capable of providing different power levels. In this embodiment, the power source 12 is preferably connected across the series combination of the heating element 28 and phase chopper circuit 26.

The phase chopper circuit 26 is preferably implemented using one or more thyristers, triacs, diacs, and/or silicon controlled rectifiers, as described in further detail in U.S. Pat. No. 6,294,874, which is incorporated herein by reference. A timer circuit 30 preferably provides a control signal that controls the phase chopper circuit 26 to trigger at a particular point on the sine curve of the AC power signal provided by the power source 12. The timer circuit 30 is preferably implemented by using an appropriately configured 555 integrated circuit timer or other conventional timing circuit known in the art. Once triggered, the phase chopper circuit 26 preferably conducts the AC power signal for the remainder of the current cycle. The longer the phase chopper circuit 26 stays on, the more power is transferred to the heating element 28, and thus the more power is output by heating element 28.

The heater of FIG. 4a preferably operates at an initial high power rating for a first time period, which is preferably 1800 watts, in response to receiving the control signal from the timer circuit 30. The heater then drops to a reduced power level for continuous operation, which is preferably 1500 watts, in response to receiving the control signal from the timer circuit 30. It will be appreciated that the phase angle control provided by the phase chopper circuit 26 described above may be substituted by, for instance, pulse width modulation control in which a field effect transistor (not shown) is controlled to modulate the conduction time of a rectified version of the AC power signal provided to the heating element 28 while remaining within the scope of the present invention.

FIG. 4b shows a fifth embodiment of the heater circuit that is similar to that shown in FIG. 4a, except that a fixed heating element 32 is connected to the circuit in parallel with the series combination of the phase chopper circuit 26 and heating element 28. The power output by the fixed heating element 32 reduces the amount of power required from the heating element 28. For example, if the fixed heating element 32 is capable of providing 500 watts, then the heating element 28 need only be varied between 1300 watts and 1000 watts. This significantly reduces the amount of power flowing through the phase chopper circuit 26, and thus its power rating and corresponding cost.

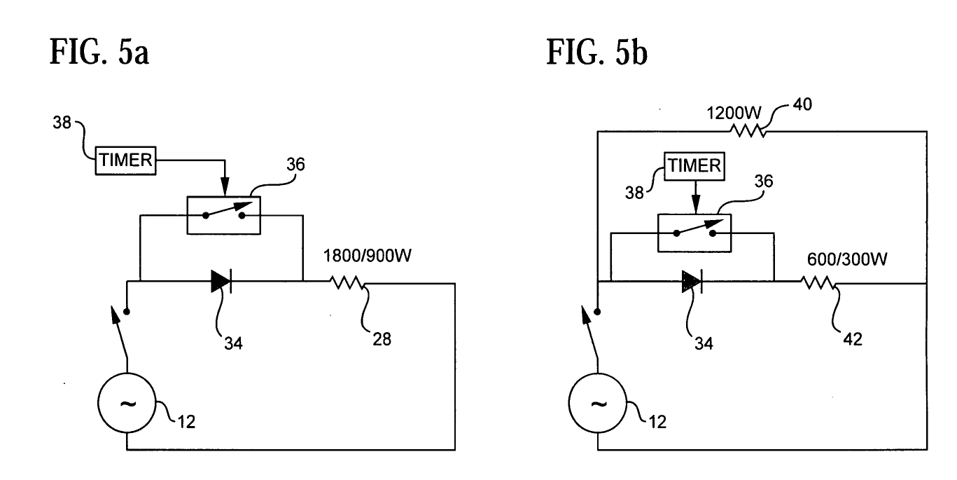

FIG. 5a shows a sixth embodiment of the two-stage heater circuit formed in accordance with the present invention, which includes a diode 34 electrically connected in series with the heating element 28. In this embodiment, the power source 12 is preferably connected across the series combination of the heating element 26 and diode 34. A switch 36 is preferably connected in parallel with the diode 34 and a timer circuit 38 provides a control signal that determines the state of the switch 36. The timer circuit 38 may be implemented by using an appropriately configured 555 integrated circuit timer or other conventional timing circuit known in the art.

If the switch 36 is open, the AC power signal flows through the diode 34, which half-wave rectifies the AC power signal provided to the heating element 28. If the switch is closed, the diode 34 is bypassed and the AC power signal flows through the switch 36 and is provided as an unrectified signal to the heating element 28. Since the half-wave rectifed AC power signal provides only about half the power of the unrectified AC power signal, assuming a negligible voltage drop across the diode 34, the power output by the heating element 28 can be made to vary between 1800 watts and 900 watts by using an element with a resistance of about 8 ohms.

The heater of FIG. 5a preferably operates at an initial high-power level for a first time period, which is preferably 1800 watts, in response to the output of the timing circuit 38 causing the switch 36 to be closed. The heater then drops to a reduced power level for continuous operation, which is preferably 1500 watts, in response to the output of the timing circuit 38 causing the switch 36 to be open.

FIG. 5b shows a seventh embodiment that is similar to that shown in FIG. 5a, except that a fixed heating element 40 is connected in parallel with the series combination of the diode 36 and heating element 42. By proper selection of the heating element resistances, the heater circuit may be adapted to output 1800 watts and 1500 watts.

For example, if the resistance of the fixed heating element 40 is chosen to be about twelve (12) ohms and the resistance of heating element 42 is chosen to be about twenty-four (24) ohms, then the fixed heating element 40 will output about 1200 watts and the heating element 42 will output about 600 or 300 watts, depending upon whether the heating element 42 receives an unrectified or half-wave rectified AC power signal, respectively. Thus, the total power output will vary between 1800 watts and 1500 watts depending upon the state (open or closed) of the switch 36.

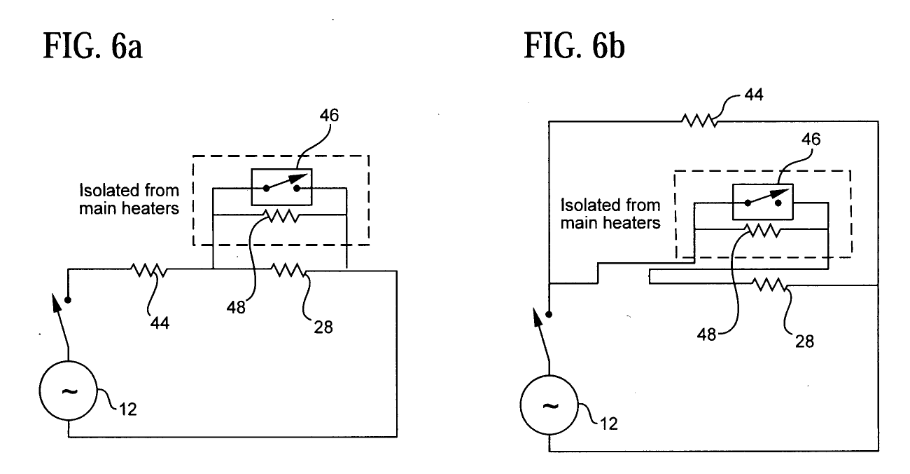

The heater circuit shown in FIG. 6a includes two heating elements 28, 44, which are preferably connected in series with the power source 12. In addition, a parallel combination of a PTC thermostat 46 and a heating element 48 are connected in parallel across heating element 28. The PTC thermostat 46 and heating element 48 are preferably insulated from the remaining heating elements 28, 44 so that heat provided by heating elements 28, 44 does not interfere with the operation of PTC thermostat 46. However, the PTC thermostat may alternatively not be isolated from the heating elements 28, 44. The PTC thermostat 46 may be implemented using part number AUT-120P, 120V 16A, which is available from Au One Electrical Fty E179137, 9^{th} Floor, Foshan Guangdong, China, or a similar substitute incorporating a lower tripping temperature.

Initially, during the high-power mode, the PTC thermostat 46 is closed to provide a low-resistance path for current flowing through heating element 44, which bypasses heating element 28. When the heat provided by heating element 48 reaches a threshold level, the PTC thermostat 46 opens to redirect current through heating element 28 during the low-power mode.

As an illustrative example, the heater circuit of FIG. 6a may be constructed to provide 1800 watts of heat during the initial heating period or high-power mode, and drop to 1500 watts of heat for the balance of the heating period during the low-power mode. For example, assume that the resistance of heating element 48 is sufficient to make its parallel contribution to the total resistance of the circuit negligible, the resistance of heating element 44 is selected to be about 8 ohms, the resistance of heating element 28 is selected to be about 1.6 ohms, and the power source has a voltage of about 120 volts AC. Initially, when heating element 28 is bypassed, the total resistance of the series circuit is 8 ohms. When heating element 28 is connected in the circuit, the total resistance of the series circuit increases to 9.6 ohms. As the voltage from power source 12 remains a substantially constant 120 volts AC, this change in resistance effectively alters the power output of the heater.

FIG. 6b shows a ninth embodiment of the two-stage heater circuit in accordance with the present invention, which is similar to that shown in FIG. 6a, except that a parallel arrangement of heating elements 28, 44 is used. In this embodiment, heating element 44 is connected in parallel with a series combination of the parallel combination (PTC thermostat 46 and heating element 48) and heating element 28. The power source 12 is preferably coupled in parallel with heating element 44.

As in the embodiments described above, the heater of FIG. 6b operates at an initial high-power level for a first time period, then drops to a reduced power level for continuous operation. Initially, when the PTC thermostat 46 is closed, the resistance of the heating elements 28, 44 combine in parallel to form a reduced total resistance. When the PTC thermostat 46 is opened, heating element 44 is the only resistance in the circuit, thereby increasing the total circuit resistance and reducing the output power.

As an example of the operation of the circuit in FIG. 6b, the heater circuit is preferably adapted to provide 1800 watts during the initial heating period and revert to outputting 1500 watts for the balance of the heating period. This is preferably achieved by selecting heating element 44 to have a resistance of 9.6 ohms, the resistance of heating element 28 to have a resistance of 48 ohms, and the external power source to supply a voltage of 120 volts AC. When power is first applied to the circuit, the PTC thermostat 46 is preferably closed and the total resistance of this circuit is the parallel combination of 48 ohms and 9.6 ohms, which is 8 ohms. After a predetermined time, the PTC thermostat 46 preferably opens, which increases the total resistance of the circuit to that of heating element 44, or 9.6 ohms.

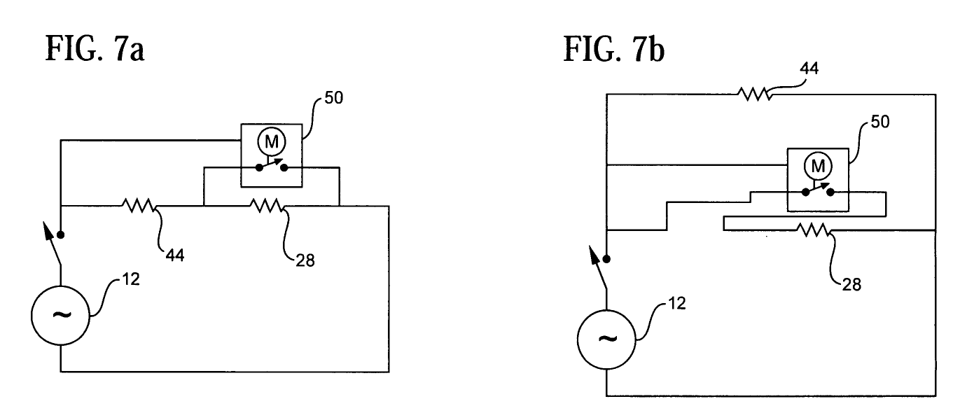

FIGS. 7a and 7b show embodiments of the heater circuit that are similar to those shown in FIGS. 6a and 6b, except that the PTC thermostat 46 and heating element 48 have been replaced by a windup timer or latching mechanical timer switch 50. Initially, in FIG. 7a, it is anticipated that the user will physically windup the mechanical timer switch 50 such that the switch remains closed. This bypasses current around heating element 28 until the timer switch 50 reaches its terminal count. At this point, the timer switch 50 preferably opens its contacts, thereby enabling current to flow through heating element 28.

Likewise, in FIG. 7b, it is anticipated that the user will physically windup the mechanical timer switch 50, such that the switch initially remains closed. This enables current to flow through heating element 28 until the timer reaches its terminal count. At this point, the mechanical timer switch 50 preferably opens its contacts, thereby bypassing current around heating element 28. The mechanical timer switch 50 may be implemented using part number DKJ/1-60, 250V, 15A, which is available from Hangzhou Westlake Timer Switch Factory, East Tower A/B, 19^{th} Floor, Hangzhou International Garden, Hangzhou, 42 Tiamushan Rd., Zhejiang 310007, China, or a similar substitute chosen in accordance with the length of operating time required by the particular application.

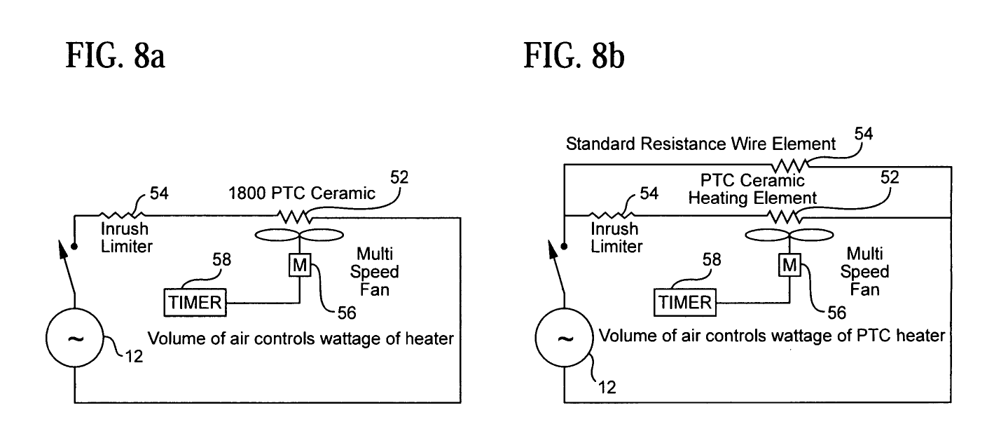

FIG. 8a shows another embodiment of the heater circuit in accordance with the present invention, which preferably includes a PTC ceramic heating element 52 and an optional inrush limiter 54 connected in series with the power source 12. The PTC ceramic heating element 52 is preferably implemented using an 1800 W part that is substantially similar to a corresponding 1500 W part having part number R0215W12, 120V, which is available from Robin Source International Co., Ltd., No. 101-1, Lane 223, Sec. 1, Taiping Rd., Tsaotun, Nantou, Taiwan. The inrush limiter 54 is preferably implemented using a negative temperature coefficient (NTC) thermistor, which functions to avoid excessive current flow through the circuit that may trip an associated circuit breaker. The inrush limiter may be implemented using part number CL-101, 16A steady state rated, which is available from Thermometrics New Jersey, 808 U.S. Highway 1, Edison, N.J. 08817-4695. It is anticipated that the inrush limiter may optionally be used (or omitted) in any of the circuits described herein while remaining within the scope of the present invention.

The circuit of FIG. 8a also preferably incorporates a multi-speed fan 56, the speed of which is preferably controlled by a timer circuit 58. The timing circuit 58 preferably switches taps associated with the multi-speed fan 56 to vary airflow, by using, for instance, triacs, relays, and the like. Alternatively, the timing circuit 58 may be adapted to provide a chopped or pulse width modulated signal to continuously and/or discretely vary the speed of a single-or multi-speed fan. These embodiments save the higher cost associated with directly switching power to the heating elements, which requires additional components and components with higher ratings. The timer circuit 58 may be implemented by using an appropriately configured 555 integrated circuit timer or other conventional timing circuit known in the art. As the speed of the fan is increased, airflow increases. As airflow increases, the wattage at which the PTC ceramic heating element 52 operates at (or self-limits to) increases.

Thus, during an initial high-power state, the speed of the fan will be operated at a first speed that will thereafter be reduced to a second speed during the low-power state. FIG. 8b shows another embodiment of the heater circuit that is substantially similar to that shown in FIG. 8a, except that an additional heating element 54 is connected in parallel with the power source 12, which enables the power output required from the PTC heating element 52 to be reduced while yielding a similar total power output from the heater circuit.

In most cases, consumers want an electric air heater that will heat an area faster, particularly when initially heating a cold area to a comfortable temperature. Conventional heaters with a 15-ampere attachment plug are limited to 1500 W in accordance with Underwriters' Laboratory (UL) standards (UL1278, 16.6). Many other UL listed products, such as hair dryers, deep fryers, toasters, electric barbeques, and the like are allowed to operate at wattages in excess of 1500 W, up to 1800 W. The rationale for permitting these devices to operate at the higher power is that the load is discontinuous or intermittent.

Therefore, electric air heaters formed in accordance with the present invention preferably operate at up to 1800 W for multiple periods of time, each not to exceed about 15 minutes, when such operation is initiated by user interaction. This allows rapid heating of an area at up to 1800 W for a short period of time followed by continuous heating at 1500 W or less.

In order to prevent the consumer from operating the heater continuously at 1800 W, the heaters in accordance with the present invention preferably operate such that they cannot be forced to remain in the high-power mode for longer than preferably 10 or 15 minutes at a time by, for example, holding down an activation button to maintain the heater in the 1800 W mode indefinitely. In order to reduce any hazards of operating at the high-power mode, the heaters formed in accordance with the present invention preferably meet each of the UL requirements imposed for continuous operation at 1800 W. The 10- or 15-minute length of operation at 1800 W is intended as an example of a preferred period of time, but can be made shorter or lengthened up to 3 hours while still being considered to be a non-continuous or intermittent load in accordance with the National Electrical Code, ANSI/NFPA 70, Article 100, “Continuous Load” and while remaining within the scope of the present invention.

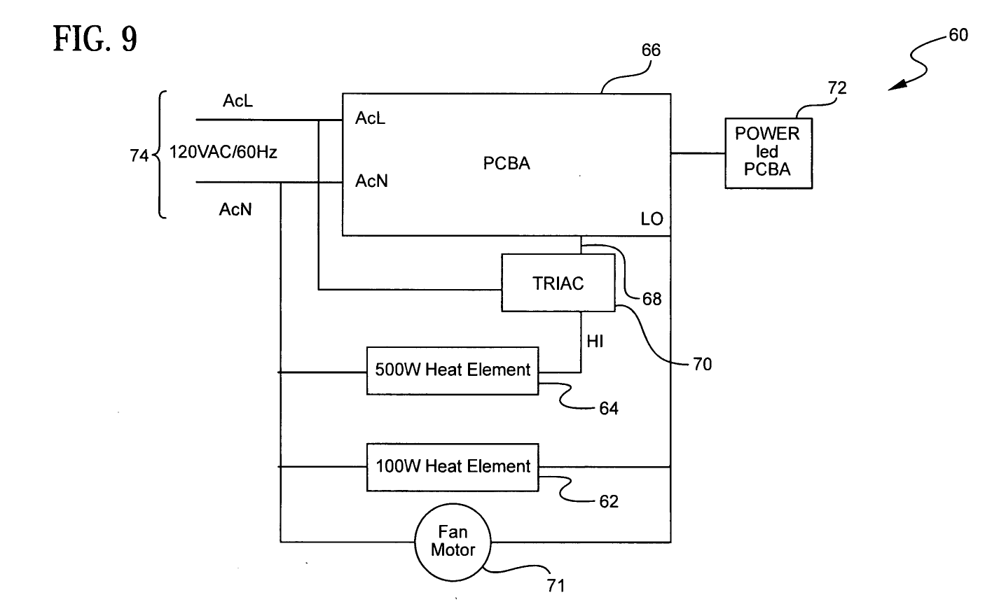

FIG. 9 shows a simplified block diagram of a fourteenth embodiment of a heater circuit 60 formed in accordance with present invention, which is adapted to save energy. During a heating cycle in an energy saving mode, a first heating element 62 is preferably adapted to be energized continuously, and a second heating element 64 is adapted to be energized for only a first period of time, such as 10 or 15 minutes. The heating cycle preferably repeats for a second period of time, such as 4 hours.

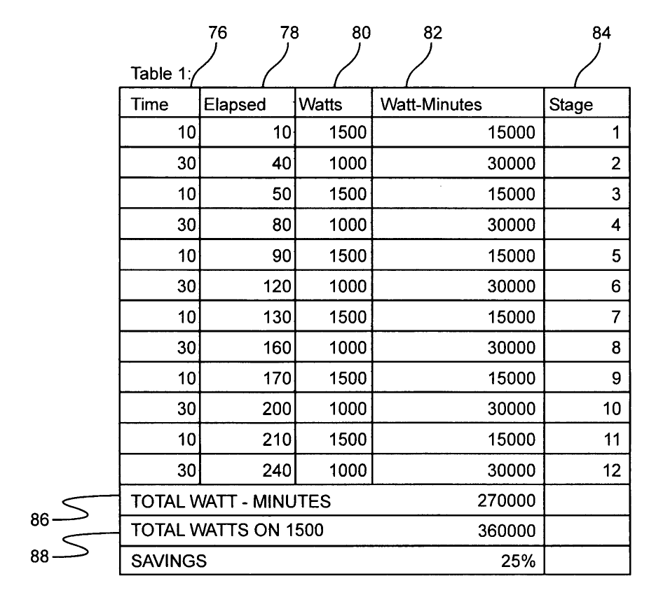

For example, during a first portion of the heating cycle, which may last 10 minutes, both the first heating element 62 and the second heating element 64 are energized to preferably dissipate 1500 W. During the remaining portion of the heating cycle, which may last 30 minutes, only the first heating element 62 is energized to preferably dissipate 1000 W. The heating cycle is preferably repeated six times, which takes four hours, before both heating elements 62, 64 are de-energized. Various parameters associated with the energy saving mode and its heating cycles are also summarized in FIG. 10, which is discussed in further detail below.

Control circuitry shown in FIG. 9 is preferably incorporated on a printed circuit board 66, which provides a control signal 68 to a triac 70 that is used to selectively energize the second heating element 64. The triac 70 is used as an alternative to an electromechanical relay to lengthen the life of the switching element used to energize the second heating element 64. A fan 70 is preferably energized during the energy saving mode and a continuous mode, in which both the first heating element 62 and the second heating element 64 are energized, to improve circulation of the heated air. Various indicator light emitting diodes (LEDs) are preferably provided on a printed circuit board 72, and the heater 60 is provided with power from a 120 volt AC 60 Hz source 74.

A preferred operation of the heater 60 and the associated heating cycles is shown in the table of FIG. 10. Stages 1 and 2, 3 and 4, or 5 and 6, and the like represent one heating cycle The first column 76 of the table indicates the amount of time spent in each of the stages of the heating cycles, which are enumerated in the last column 84 of the table. The second column 78 of the table indicates the time that has elapsed, and the third column 80 of the table indicates the power in watts during any particular stage. The fourth column 82 of the table indicates the total amount of watt-minutes used during any stage. The total number of watt-minutes in all the stages is summed at references numeral 86, which represents a 25% savings in power over that which would have been provided if both the first heating element and the second heating element were energized continuously during each of the twelve stages. The total watt-minutes for the twelve stages is shown at reference numeral 88.

The heater 60 preferably incorporates two energy saving techniques that are automatically activated once the heater 60 is turned on. Firstly, the heater 60 preferably cycles between high and low wattages for the 4-hour period shown in FIG. 10. In addition, the heater 60 is equipped with a 4-hour timer that is automatically activated once the heater is turned on. After 4 hours have expired, the heater automatically shuts down. To turn the heater back on, human intervention is preferably required.

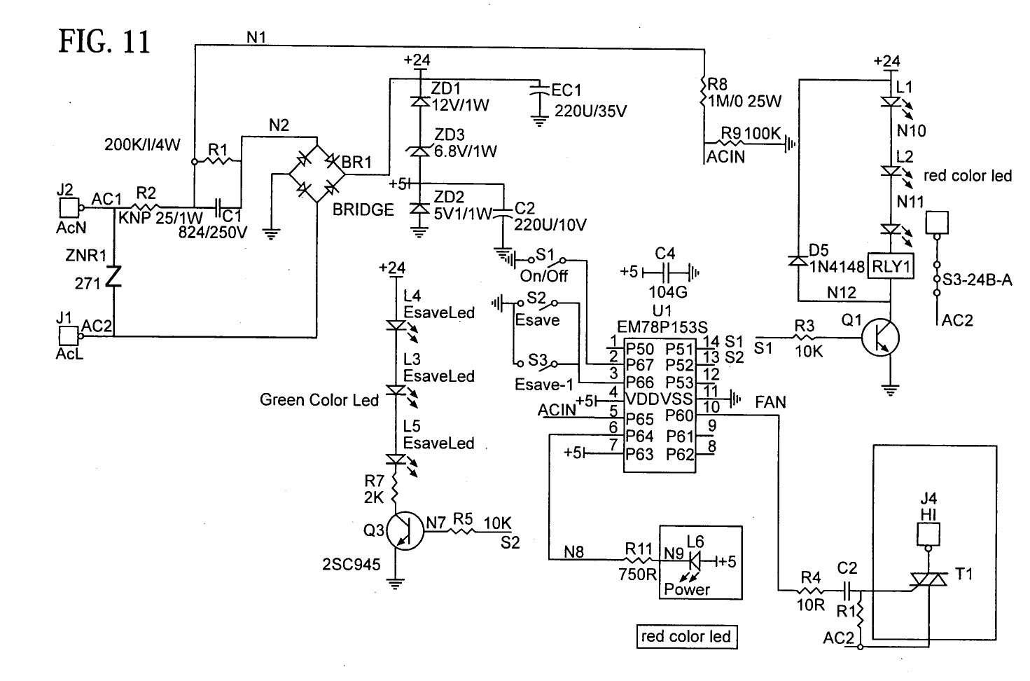

FIG. 11 shows a schematic of the heater 60 shown in FIG. 9. The 4-hour timer described above may be deactivated by depressing S2 and/or S3 and the energy saving mode may be reinitiated by again depressing S2 and/or S3. The AC power source 74 is preferably connected to connectors J1 and J2, which is connected in series with resistor R2 that preferably functions to protect the remaining circuitry from impulse currents. Capacitor C1 is preferably connected in series with resistor R2 and a full-wave bridge rectifier BR1. Capacitor C1 functions as an active impedance to dampen any current spikes that would have been applied to the remaining circuitry.

The bridge rectifier BR1 functions to rectify the input AC source voltage to a full-wave rectified DC voltage, which is then applied to a series of Zener diodes ZD1-ZD3 connected in series between ground and an output of the bridge rectifier BR1. The output of the bridge rectifier BR1 is also connected to ground through a bypass capacitor EC1. A 24-volt rectified DC power source is provided at the cathode of Zener diode ZD1. At the output of the bridge rectifier BR1, a 5-volt DC power source is provided at the cathode of Zener diode ZD2, which is also connected to ground through a bypass capacitor C2.

A series combination of three light emitting diodes LEDs L3-L5 and a resistor R7 are preferably connected in series between the 24-volt DC power source and the collector of transistor Q3. The emitter of transistor Q3 is preferably connected to ground, and a resistor R5 is connected in series between the base of transistor Q3 and pin 13 of a microcontroller U1. Switch S1 is preferably connected in a series between ground and pin 2 of microcontroller U1 and functions to turn the heater 60 on or off. Switches S2 and S3 are connected in parallel with each other, electrically connected in series between ground and pin 3 of microcontroller U1, and operate to activate the energy saving mode.

A bypass capacitor C4 is preferably connected in series between the 5-volt DC power supply and ground. LED L6 is preferably connected in series with a resistor R11 between the 5-volt DC power supply and pin 6 of the microcontroller U1 to indicate whether the heater 60 has been powered on. Resistor R1 is preferably connected in parallel across capacitor C1, and resistors R8 and R9 are connected in series between ground and a node between resistor R2 and capacitor C2. A node 76 between resistors R8 and R9 is connected to pin 4 of microcontroller U1 and used to sample the AC power source. Resistors R8 and R9 function as a zero-crossing detect circuit that is used to determine whether the AC power source 74 is acceptable. Once power is lost, the system can stop and reset the resistor within 0.2 seconds to ensure that the functions handled by the microcontroller remain under control.

Pin 14 of microcontroller U1 is preferably connected to the base of transistor Q1 through resistor R3, and the emitter of transistor Q1 is connected to ground. Two LEDs L1, L2, which indicate whether the heater 60 is on, and a relay RLY1 are connected in series between the 24-volt power source and the collector of transistor Q1.

Resistor R4 and capacitor C2 are preferably connected in series between the control input of a triac T1 and pin 9 of microcontroller U1. A resistor R1 is preferably connected in series between the control input of triac T1 and connector J1. An output of the triac T1 is connected to the second heating element 64 and an input of the triac T1 is connected to connector J1, the AC power source 74. A pulse on pin 9 of the microcontroller U1 preferably triggers the triac T1, which causes the second heating element 64 to be connected to the AC power source. Similarly, an active-low signal on pin 14 of microcontroller U1 preferably turns transistor Q1 on, which energizes relay RLY1 and connects the first heating element 62 to the AC power source 74. In this way, the microcontroller U1 is able to control energization of the first and second heating elements 62, 64. An active-low signal on pin 13 of the microcontroller U1 turns transistor Q3 on, which energizes LEDs L3-L5 to indicate that the energy saving mode has been activated.

Preferably, the first heating element 62 is about 1,000 watts and the second heating element 64 is about 500 watts. Operationally, when the heater 60 is first plugged in, the heater 60 is preferably in an off mode. During the off mode, if switches S2, S3 are selected, the heater 60 preferably does nothing. However, in the off mode, if the on/off switch S1 is depressed, the heater 60 will initiate the energy saving mode. When the heater 60 is the energy saving mode, if switches S2, S3 are selected, the heater 60 will change to the continuous mode, and if the on/off switch S1 is selected, the heater 60 will enter the off mode. When the unit is in continuous mode, selecting the energy saving mode switches S2, S3 preferably causes the heater 60 to enter the energy saving mode, and selecting the on/off switch S1 preferably causes the heater 60 to enter the off mode.

It will be appreciated by those skilled in the art, that the concept of a two-stage heating circuit, as illustrated in the figures, can be extended to a multi-stage heater, with one or more wattage settings by adding additional heating elements and additional control elements. It will further be appreciated that the specific values of the power ratings concerning the modes of operation discussed herein are intended as examples only and do not in any way limit the intended scope of the invention. It will yet further be appreciated that the fuse 6, thermostat 8, current sensor 18, and display element 20 may be implemented in the circuits shown in any of the figures.

Further, it will be appreciated that once the heater circuit enters the second reduced power state, the circuit could, as an option, remain in this state until the circuit is de-energized or the user intervenes, such as by depressing a button. This feature would enhance the safety of the heater by restricting its operation at the higher power state to only a limited period of time.

As another option, the feature described immediately above concerning entry into the reduced power state could be made non-defeatable by the user. That is, the user would not be able to force the heater to run continuously at the higher power setting. For example, despite the user's continuously or intermittently depressing a button to remain in the higher power setting, the heater may still time out and enter the reduced power setting.

As yet another option, the feature concerning entry into the reduced power state could be adapted to cycle back up to the higher power state in response to, for instance, the ambient temperature dropping to a lower threshold temperature. This option could be activated automatically or in response to user intervention.

It will also be appreciated that the present invention is equally applicable to any type of heater, such as, but not limited to, oil-filled heaters, radiant panel heaters, and air heaters while remaining within the scope of the present invention.

Thus, it will be understood by those skilled in the art that the heaters in accordance with the present invention are adapted to rapidly heat a space without increasing the risk of fire while operating at an initially higher power level (such as 1800 W) at the beginning of a heating cycle, then automatically dropping to one or more lower power levels for continuous and/or thermostatic operation (such as 1000 W) followed by thermostatic operation at 500 W.

It will also be understood by those skilled in the art that the heater in accordance with the present invention operates at a higher power level (such as 1500 W) during a first portion of a heating cycle, then automatically drops to a lower power level (such as 1000 W) for a second portion of the heating cycle. This heating cycle may repeat for a predetermined duration (such as 4 hours) or continuously, and will rapidly heat a space while saving energy.

Although illustrative embodiments of the present invention have been described herein with reference to the accompanying drawings, it is to be understood that the invention is not limited to those precise embodiments, and that various other changes and modifications may be effective therein by one skilled in the art without departing from the scope or spirit of the invention.

What is claimed is:

1. An electric space heater comprising:
a first heating element; and
a power modification circuit electrically connected in series with the first heating element, the power modification circuit adapted to selectively modify power provided to the first heating element, thereby enabling the electric space heater to operate at at least one of a first operating power and a second operating power.

2. The electric space heater defined by claim 1, wherein the modification circuit further comprises a phase chopper adapted to conduct a selectable portion of an AC power signal to the first heating element in response to a timing signal, thereby enabling the electric space heater to operate at at least one of the first operating power and the second operating power.

3. The electric space heater defined by claim 2, wherein the phase chopper comprises at least one of a thyristor, triac, diac, and silicon controlled rectifier.

4. The electric space heater defined by claim 2, further comprising a second heating element electrically connected in parallel with the series combination of the first heating element and the phase chopper.

5. The electric space heater defined by claim 1, wherein the power modification circuit further comprises a pulse width modulator adapted modulate a rectified AC power signal in response to a timing signal and conduct the modulated rectified AC power signal to the first heating element, thereby enabling the electric space heater to operate at at least one of the first operating power and the second operating power.

6. The electric space heater defined by claim 5, wherein the pulse width modulator comprises a field effect transistor.

7. The electric space heater defined by claim 5, further comprising a second heating element electrically connected in parallel with the series combination of the first heating element and the pulse width modulator.

8. The electric space heater defined by claim 1, wherein the power modification circuit further comprises:
a switch adapted to selectively provide one of a closed circuit and an open circuit in response to a timing signal; and
a diode electrically connected in parallel with the switch, the diode adapted to rectify an AC power signal and conduct the rectified AC power signal to the first heating element in response to the switch providing an open circuit, thereby enabling the electric space heater to operate at the first operating power, the switch providing a bypass path for the AC power signal in response to the switch providing a closed circuit, thereby enabling the electric space heater to operate at the second operating power.

9. The electric space heater defined by claim 8 further comprising a second heating element electrically connected in parallel with the series combination of the first heating element and the diode.

10. An electric space heater comprising:
a first heating element;
a second heating element electrically connected in series with the first heating element; and
a switch electrically connected in parallel with the second heating element, the switch selectively providing a closed circuit, thereby enabling an AC power signal to substantially bypass the second heating element and enabling the electric space heater to operate at a first operating power, the switch selectively providing an open circuit, thereby enabling the AC power signal to flow through the second heating element and enabling the electric space heater to operate at a second operating power.

11. An electric space heater defined by claim 10, wherein the switch further comprises:
a third heating element; and
a thermostatic switch selectively providing one of the closed circuit and the open circuit in response to heat dissipated by the third heating element.

12. An electric space heater defined by claim 11 wherein the third heating element is electrically connected in parallel with the thermostatic switch.

13. An electric space heater defined by claim 10, wherein the switch further comprises a mechanical timer switch.

14. An electric space heater comprising:
a first heating element;
a second heating element; and
a switch electrically connected in series with the second heating element, the first heating element being electrically connected in parallel with the series combination of the switch and the second heating element, the switch selectively providing an open circuit, thereby enabling an AC power signal to substantially bypass the second heating element and enabling the electric space heater to operate at a first operating power, the switch selectively providing a closed circuit, thereby enabling the AC power signal to be provided to the second heating element and enabling the electric space heater to operate at a second operating power.

15. An electric space heater defined by claim 14, wherein the switch further comprises:
a third heating element; and
a thermostatic switch selectively providing one of the closed circuit and the open circuit in response to heat dissipated by the third heating element.

16. An electric space heater defined by claim 15, wherein the third heating element is electrically connected in parallel with the thermostatic switch.

17. An electric space heater defined by claim 14, wherein the switch further comprises a mechanical timer switch.

18. An electric space heater comprising:
a fan adapted to move a volume of air; and
a first heating element adapted to selectively operate at different powers in response to the volume of air moved across the first heating element by the fan, thereby enabling the electric space heater to operate at at least one of a first operating power and a second operating power.

19. The electric space heater defined by claim 18, wherein the first heating element further comprises a positive temperature coefficient (PTC) ceramic heating element.

20. The electric space heater defined by claim 18, further comprising an inrush limiter electrically connected in series with the first heating element.

21. The electric space heater defined by claim 18, further comprising a second heating element electrically connected in parallel with the first heating element.

22. An electric space heater comprising:
a control unit;
a first heating element energized in response to the control unit during at least a portion of a heating cycle; and
a second heating element energized continuously in response to the control unit during the heating cycle, the heating cycle being repeated for a time period following which the first heating element and the second heating element are de-energized.

23. The electric space heater defined by claim 22, wherein the portion of the heating cycle is 15 minutes long.

24. The electric space heater defined by claim 22, wherein the time period is 4 hours long.

25. The electric space heater defined by claim 22, further comprising a triac responsive to the control unit, the triac selectively energizing the first heating element.

26. The electric space heater defined by claim 22, the electric space heater further comprising a continuous mode, wherein the first heating element and the second heating element are continuously energized.
